(19) United States
(12) Patent Application Publication
(10) Pub. No.: US 2018/0375128 A1
(43) Pub. Date: Dec. 27, 2018

(54) FLOW BATTERY STACK COMPRESSION ASSEMBLY

(71) Applicant: PRIMUS POWER CORPORATION, Hayward, CA (US)

(72) Inventors: Paul KREINER, San Francisco, CA (US); Kyle HAYNES, Redwood City, CA (US); Simo ALBERTI, San Luis Obispo, CA (US); Felix WINKLER, San Leandro, CA (US)

(21) Appl. No.: 15/634,509

(22) Filed: Jun. 27, 2017

(51) Int. Cl. H01M 8/04276; H01M 8/0271; H01M 8/0289; H01M 8/0297

(52) U.S. Cl. CPC H01M 8/04283; H01M 8/0297; H01M 8/0289; H01M 8/0271

(57) ABSTRACT

A flow battery includes a compression assembly including one or more biasing devices, a first compression member, an opposing second compression member, and a flow battery stack located between the first and second compression members. The flow battery stack includes stacked electrodes located in a central portion of the flow battery stack, and cell frames located in an edge portion of the flow battery stack and that surround the electrodes. The compression assembly is configured to apply a higher biasing force to the stacked electrodes located in the central portion of the flow battery stack than to the cell frames located in the edge portion of the flow battery stack.

### FIELD

The present invention is directed to flow battery compression assemblies.

### BACKGROUND

The development of renewable energy sources has revitalized the need for large-scale batteries for off-peak energy storage. The requirements for such an application differ from those of other types of rechargeable batteries such as lead-acid batteries. Batteries for off-peak energy storage in the power grid generally are required to be of low capital cost, long cycle life, high efficiency, and low maintenance.

One type of electrochemical energy system suitable for such an energy storage is a so-called “flow battery” which uses a halogen component for reduction at a normally positive electrode in discharge mode, and an oxidizable metal adapted to become oxidized at a normally negative electrode during the normal operation of the electrochemical system. An aqueous metal halide electrolyte is used to replenish the supply of halogen component as it becomes reduced at the positive electrode. The electrolyte is circulated between the electrode area and a reservoir area. One example of such a system uses zinc as the metal and chlorine as the halogen.

Such electrochemical energy systems are described in, for example, U.S. Pat. No. 3,713,888, 3,993,502, 4,001,036, 4,072,540, 4,146,680, and 4,414,292, the disclosures of which are hereby incorporated by reference in their entirety.

Typical conventional flow batteries contain separate flow loops and pumps for the anode and cathode. In addition, the two electrodes need to be separated by a barrier such as a membrane, which needs to be replaced over time. This separation of cathode and anode leads to high manufacturing and maintenance costs, but without this separation, the cell is susceptible to high auto-discharge, resulting in much lower energy output and efficiency.

### SUMMARY

Exemplary embodiments of the present disclosure provide a flow battery which includes a compression assembly comprising one or more biasing devices, a first compression member, and an opposing second compression member; and a flow battery stack comprising: stacked electrodes located in a central portion of the flow battery stack; and cell frames located in an edge portion of the flow battery stack and that surround the electrodes. The flow battery stack is located between the first and second compression members, and the compression assembly is configured to apply a higher biasing force to the stacked electrodes located in the central portion of the flow battery stack than to the cell frames located in the edge portion of the flow battery stack.

### BRIEF DESCRIPTION OF THE DRAWINGS

FIGS. 1A-1C are side cross-sectional views of flow battery cells, according to various embodiments of the present disclosure.

FIGS. 2A-2C are side cross-sectional views of flow battery stacks and FIG. 2D is a side-cross sectional view of a flow battery system, according to various embodiments of the present disclosure.

FIGS. 3A and 3B are respectively top and bottom plan views of a battery cell support frame, according to various embodiments of the present disclosure.

FIGS. 3C and 3D are respectively top and bottom perspective views of a flow battery stack including the frame of FIGS. 3A and 3B.

FIG. 3E is a sectional view of a flow battery stack, according to various embodiments of the present disclosure.

FIG. 4 is a side cross-sectional view of a related art flow battery compression assembly.

FIG. 5A is a side cross-sectional view of a flow battery compression assembly according to various embodiments of the present disclosure.

FIG. 5B is a side cross-sectional view of a modified version of the flow battery compression assembly of FIG. 5A.

FIG. 6 is a side cross-sectional view of a flow battery compression assembly according to various embodiments of the present disclosure.

FIG. 7 is a side cross-sectional view of a flow battery compression assembly according to various embodiments of the present disclosure.

FIG. 8 is a side cross-sectional view of a flow battery compression assembly according to various embodiments of the present disclosure.

FIG. 9 is a side perspective view of a flow battery compression assembly according to various embodiments of the present disclosure.

FIG. 10 is a side perspective view of a flow battery compression assembly according to various embodiments of the present disclosure.

FIG. 11A is a side perspective view of a flow battery compression assembly according to various embodiments of the present disclosure.

FIG. 11B is a perspective view of a pressure bar of FIG. 11A.

### DETAILED DESCRIPTION

Typical conventional flow battery stacks are disposed in compression assemblies to maintain flow characteristics through the stacks. However, the present inventors realized that such compression assemblies may bend stack components, resulting in poor quality plating and reduced efficiency. Embodiments of the present invention are drawn to compression assemblies for metal-halogen flow battery stacks and systems that may overcome or reduce these and/or other problems.

In some embodiments, the systems may include flow architecture with a single flow circuit. Conventional metal halogen flow batteries maintain electrochemical efficiency by keeping reactant streams contained in two distinct flow loops by using a separator between the positive and negative electrodes of each flow cell and separate reservoirs for the electrolyte and the halogen reactant. The configurations below describe systems and methods for reactant handling that combine the simplicity and reliability of a single flow loop system with reactant separation balance of plant (BOP) components. Preferably, the single flow loop system includes a stack of flow battery cells without a separator between the positive and negative electrodes of each flow cell (i.e., the reaction zone is not partitioned) and a common reservoir for the electrolyte and the concentrated halogen reactant.

The electrochemical (e.g., flow battery) system can include a vessel containing one or more electrochemical cells (e.g., a stack of flow battery cells) in its inner volume, a metal-halide electrolyte, and a flow circuit configured to deliver the metal-halide electrolyte to the electrochemical cell(s). The flow circuit may be a closed loop circuit that is configured to deliver the electrolyte to and from the cell(s). In many embodiments, the loop circuit may be a sealed loop circuit.

Each of the electrochemical cell(s) may comprise a first electrode, which may serve as a negative electrode, a second electrode, which may serve as a positive electrode, and a reaction zone between the electrodes. The first and second electrodes may be formed of a non-permeable metal or carbon material, such as coated steel, graphite, titanium, tantalum, an/or niobium. The second electrode may include through holes in the non-permeable material. Alternatively, the second electrode may be made of a permeable material. The second electrode may be coated with ruthenium oxide (e.g., ruthenized titanium). The second electrode may have a roughened surface.

In discharge and charge modes, the second electrode may serve as a positive electrode at which the halogen may be reduced into halogen ions. The first electrode may operate as a negative electrode and may comprise a primary depositable and oxidizable metal, i.e., a metal that may be oxidized to form cations during the discharge mode. For example, the first electrode may comprise a metal that is of the same type as a metal ion in one of the components of the metal halide electrolyte. For example, when the metal halide electrolyte comprises zinc halide, such as zinc chloride and/or zinc bromide, the first electrode may comprise metallic zinc. Alternatively, the first electrode may comprise another material, such as titanium that is plated with zinc.

In various embodiments, the reaction zone lacks a separator and an electrolyte circulates through the same flow path (e.g., single loop) without a separation between the electrodes in each cell. In other words, the reaction zone may be such that it does not contain a membrane or a separator between the positive and negative electrodes of the same cell that is impermeable to the halogen ions in the electrolyte. Furthermore, the cell may be a hybrid flow battery cell rather than a redox flow battery cell. Thus, in the hybrid flow battery cell, a metal, such as zinc is plated onto one of the electrodes, the reaction zone lacks an ion exchange membrane which allows ions to pass through it (i.e., there is no ion exchange membrane between the cathode and anode electrodes) and the electrolyte is not separated into a catholyte and anolyte by the ion exchange membrane. The electrolyte is stored in one reservoir rather than in separate catholyte and anolyte reservoirs.

According to various embodiments, provided is a flow battery system that may be reversible, i.e., capable of working in both charge and discharge operation mode. The reversible system usually utilizes at least one metal halide in the electrolyte, such that the metal of the metal halide is sufficiently strong and stable in its reduced form to be able to form an electrode. The metal halides that can be used in the reversible system include zinc halides, as element zinc is sufficiently stable to be able to form an electrode. Preferably, the electrolyte is aqueous solution of at least one metal halide electrolyte compound, such as ZnBr₂ and/or ZnCl₂. For example, the solution may be a 15-50% aqueous solution of ZnBr₂ and/or ZnCl₂, such as a 25% solution. In certain embodiments, the electrolyte may contain one or more additives, which can enhance the electrical conductivity of the electrolytic solution. For example, when the electrolyte contains ZnCl₂, such additive can be one or more salts of sodium or potassium, such as NaCl or KCl.

In certain embodiments, the electrolyte may contain one or more additives, which can enhance the electrical conductivity of the electrolytic solution. For example, when the electrolyte contains ZnBr₂, such additive can be one or more of Pb or Bi.

When the electrolyte contains ZnBr₂, then the electrolyte may also contain a bromine sequestering/complexing agent. For example, the bromine sequestering agent may be one or more of a morpholinium, pyrrolidinium, imidazolium, picolinium or pyridinium salt, and a quaternary ammonium bromide (QBr). In some embodiments, the bromine sequestering agent may be at least one of 1-dodecyl-1-methylmorpholinium bromide, 1-dodecyl-1-methylpyrrolidinium bromide, 1-dodecylpyridinium bromide, dodecyltrimethylammonium bromide, benzyldodecyldimethylammonium bromide, tetrabutylammonium bromide, 1-ethyl-1-methylpyrrolidinium bromide (MEP), and 1-ethyl-1-methyl-morpholinium bromide (MEM). In an embodiment, these compounds include any substitution derivatives of the compounds listed (e.g., those containing additional alkyl substituents) as well as different alkyl chain lengths. Preferably, the electrolyte composition includes about 7-27% (w/v) of the bromine sequestering agent. More preferably, the electrolyte composition includes about 14-23% (w/v) of the bromine sequestering agent.

In certain embodiments, the electrolyte may contain one or more additives. Examples of such additives may be found in U.S. Patent Application Publication No. 2016/0276691A, published on Sep. 22, 2016, which is incorporated herein by reference in its entirety.

Without wishing to be bound to any particular theory, it is believed the bromine sequestering agent allows the electrolyte to form a biphasic mixture including a first phase and a second phase disposed below the first phase. The first phase may be an aqueous phase including a lighter metal-halide electrolyte (e.g., aqueous zinc bromide). The second phase may be a non-aqueous phase that includes a concentrated halogen reactant (e.g., sequestered bromine). As used herein, a “concentrated halogen reactant” may include electrolyte with higher than stoichiometric halogen content (e.g., higher halogen content than 1:2 zinc to halogen ratio for zinc-halide electrolyte), pure liquid halogen (e.g., liquid chlorine and/or bromine), or chemically-complexed halogen, such as a bromine-MEP or another bromine-organic molecule complex.

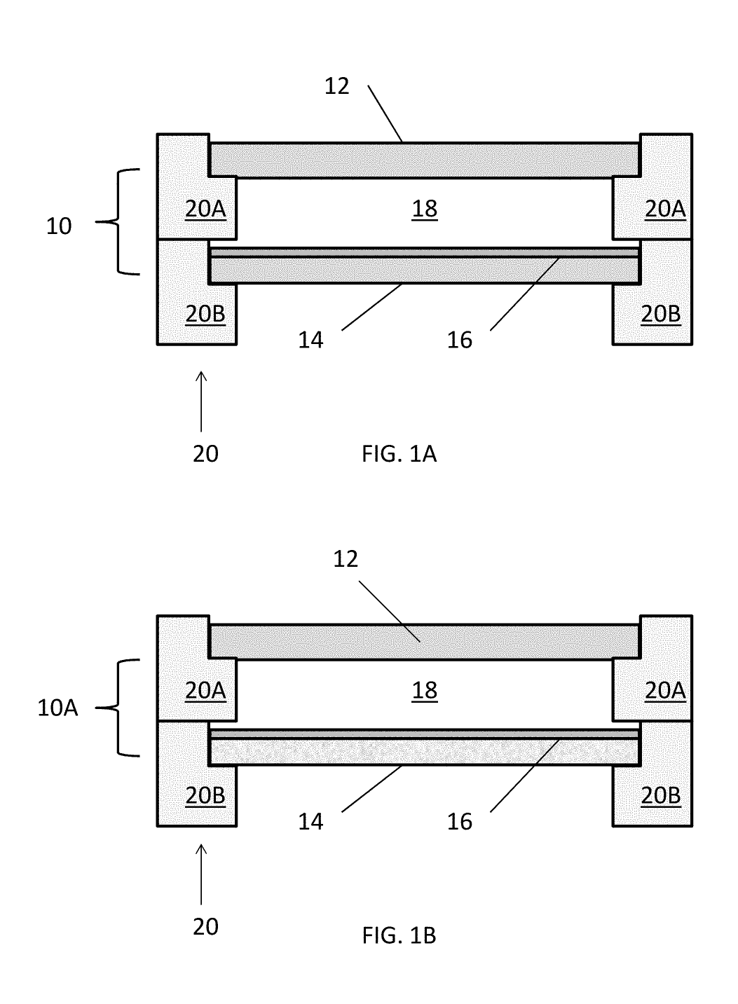

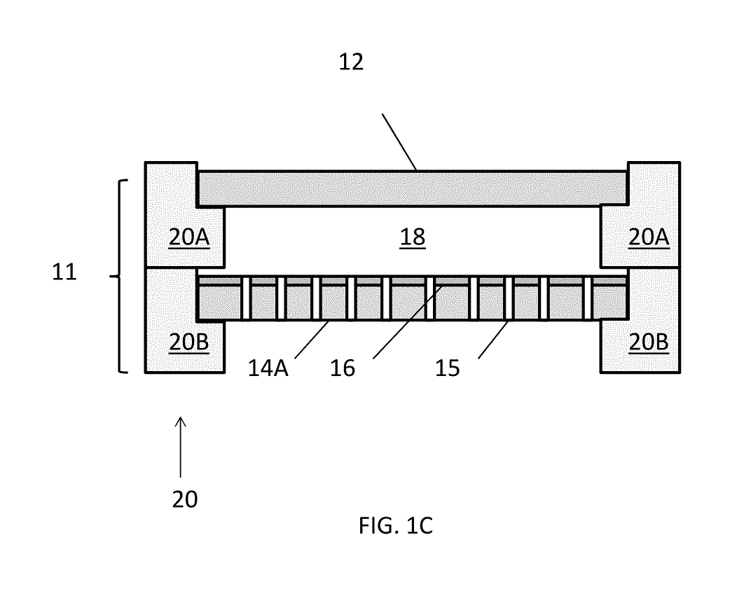

FIG. 1A illustrates a sectional view of a flow battery cell 10, according to various embodiments of the present disclosure. Referring to FIG. 1A, the battery cell 10 includes a first electrode 12 and a second electrode 14 that are separated by a reaction zone 18. Herein, for convenience, the first electrode 12 may be referred to as a negative electrode 12, and the second electrode 14 may be referred to as a positive electrode 14. The first electrode 12 may be formed of a sheet of an impermeable metal or carbon material having a substantially uniform thickness. For example, the first electrode 12 may include coated steel, graphite, titanium, tantalum, and/or niobium. The first electrode 12 may have a roughened surface to increased plating adhesion.

The second electrode 14 may be formed of a sheet of impermeable metal or carbon material having a substantially uniform thickness. For example, the second electrode 14 may include coated steel, graphite, titanium, tantalum, and/or niobium. The second electrode 14 may have a roughened surface to increase the surface area thereof. The second electrode 14 may be coated with a mixed-metal oxide layer 16 that may operate as a catalyst. For example, the mixed-metal oxide layer 16 may include ruthenium oxide (e.g., ruthenized titanium).

The electrodes 12, 14 may be disposed in a cell frame structure 20 configured to maintain the reaction zone 18 between the electrodes 12, 14. In particular, the cell frame structure 20 may include a first frame 20A configured to support the first electrode 12 and a second frame 20B configured to support the second electrode 14. The frames 20A, 20B may support and surround the corresponding electrodes 12, 14 and may be configured to be stacked on one another to form the frame structure 20. The frame structure 20 may also be configured to provide electrolyte to the flow battery cell 10, as discussed in detail below.

FIG. 1B illustrates a sectional view of a flow battery cell 10A, according to various embodiments of the present disclosure. The flow battery cell 10A is similar to the flow battery cell 10, so only differences therebetween will be discussed in detail. Referring to FIG. 1B, the flow battery cell 10A includes the second electrode 14 may be coated with a mixed-metal oxide layer 16 that may operate as a catalyst. For example, the mixed-metal oxide layer 16 may include ruthenium oxide (e.g., ruthenized titanium). The second electrode 14 and the mixed-metal oxide layer 16 may be porous (e.g., may be formed of a felt or foamed material) to permit electrolyte to flow there through.

FIG. 1C illustrates a sectional view of a flow battery cell 11, according to various embodiments of the present disclosure. The flow battery cell 11 is similar to the flow battery cell 10, so only differences therebetween will be discussed in detail. Referring to FIG. 1C, the flow battery cell 11 includes a second electrode 14A that may be formed of the same material as the second electrode 14, but also includes through holes 15 through which an electrolyte can flow there through. The through holes 15 may extend from upper to lower surfaces of the second electrode 14. In other words, the through holes 15 may extend entirely though the thickness of the second electrode 14. Accordingly, the second electrode 14A may be porous (i.e., perforated), due to the through holes 15, but is formed of a non-permeable material, as described above with regard to the second electrode 14 of FIG. 1A.

The electrodes 12, 14A may be disposed in first and second cell frames 20A, 20B configured to maintain the reaction zone 18 between the electrodes 12, 14A. In particular, the first electrode 12 may be supported by the first frame 20A, and the second electrode 14A may be supported by a second frame 20B. The frames 20A, 20B may support and surround the corresponding electrodes 12, 14A and may be configured to be alternately stacked on one another to form a frame structure. The frames 20A, 20B may also be configured to provide electrolyte to the flow battery cell 11, as discussed in detail below.

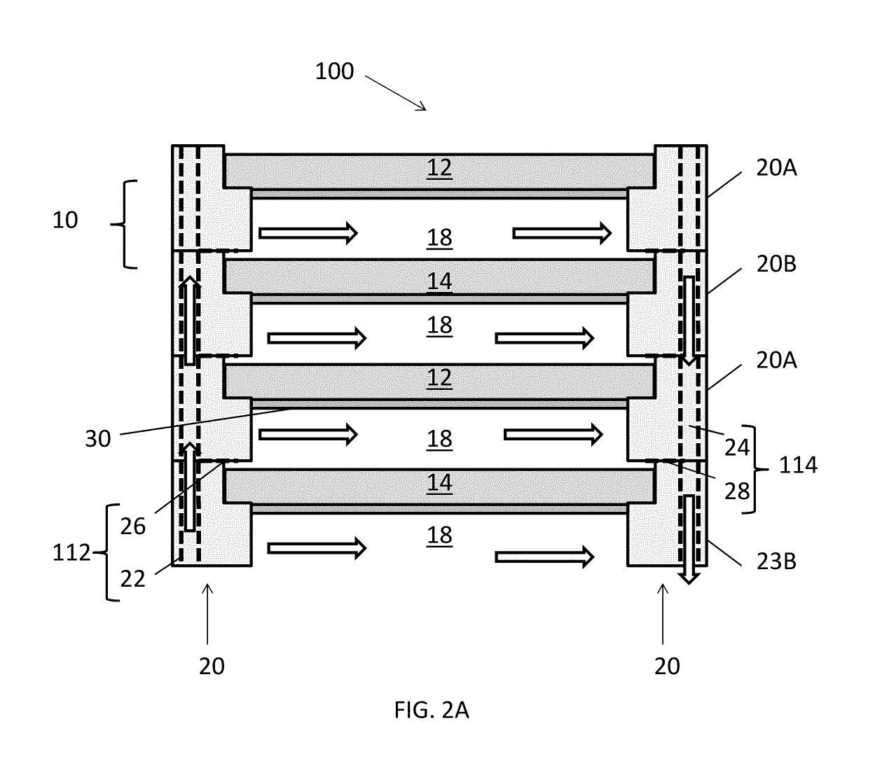

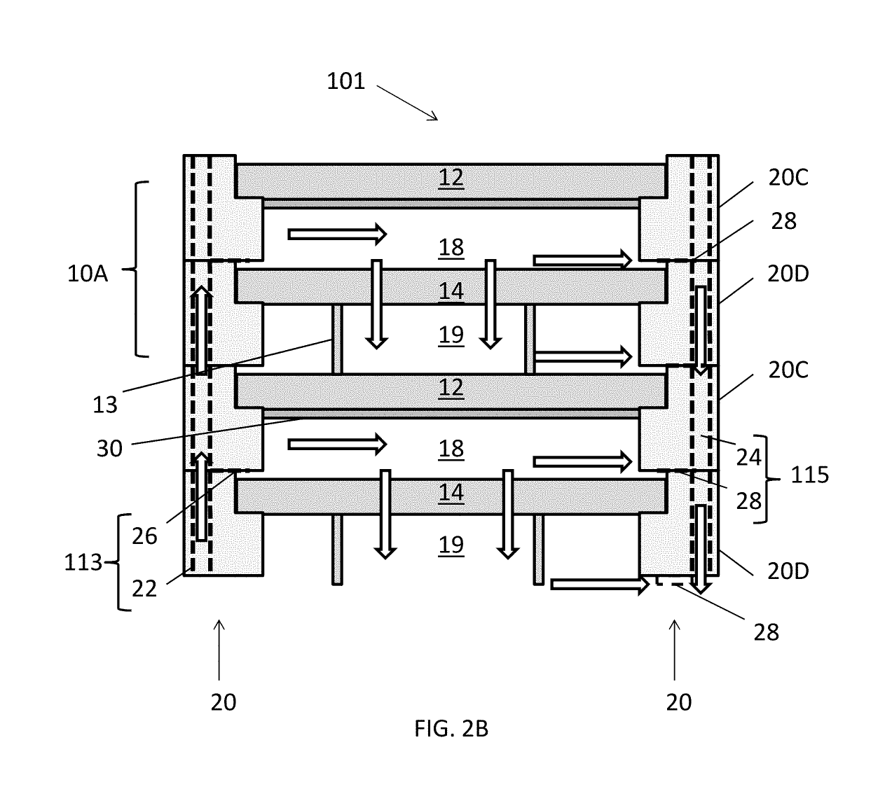

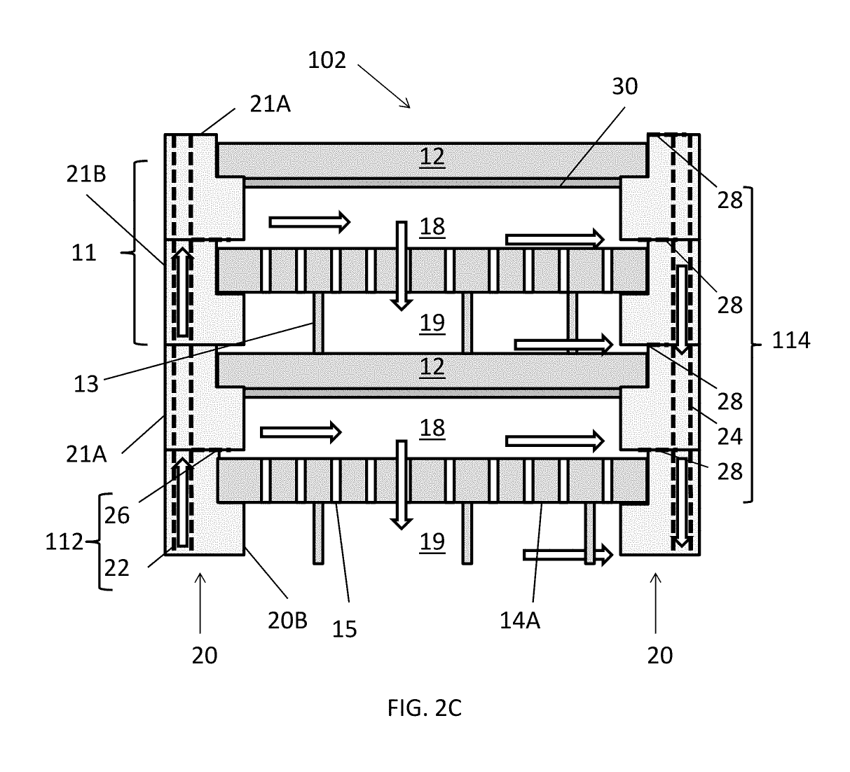

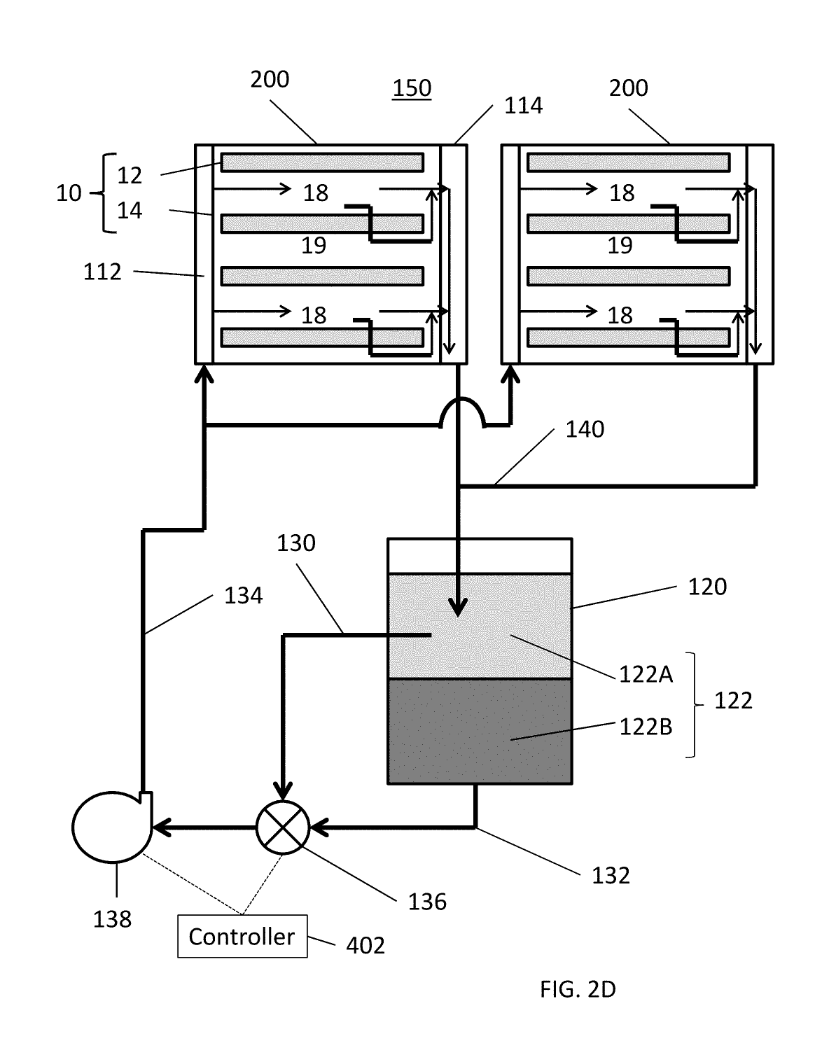

FIG. 2A is a side sectional view of a flow battery stack 100 including multiple flow battery cells 10 of FIG. 1A, which are connected in series, according to various embodiments of the present disclosure. FIG. 2B is a side sectional view of a flow battery stack 101 including multiple flow battery cells 10A of FIG. 1B, which are connected in series, according to various embodiments of the present disclosure. FIG. 2C is a side sectional view of a flow battery stack 102 including multiple flow battery cells 11 of FIG. 1C, according to various embodiments of the present disclosure.

Referring to FIG. 2A, the stack 100 is shown to include multiple flow battery cells 10. In particular, each flow battery cell 10 includes a portion of a first electrode 12 and a portion of an adjacent second electrode 14. In other words, the electrodes 12, 14 may be shared between adjacent battery cells 10. In particular, charge separation may occur in the electrodes 12, 14, such that each electrode has a positive portion and an opposing negative portion. While the stack 100 is shown to include four flow battery cells 10, any suitable number of flow battery cells 10 may be included in the stack 100.

The stack 100 includes a frame structure 20 configured to support the electrodes 12, 14, such that the electrodes 12, 14 are separated by reaction zones 18. The frame structure 20 includes first and second frames 20A, 20B, which are alternately stacked on one another. The first electrodes 12 may be supported by first frames 20A, and the second electrodes 14 may be supported by second frames 20B. The first and second frames 12, 14 may respectively surround the first and surround electrodes 12, 14. The frame structure 20 may be formed of high density polyethylene (HDPE), polypropylene, polyvinylidene fluoride (PVDF), Teflon, a borosilicate glass, and/or an aluminosilicate glass.

The frame structure 20 may include features designed to provide the electrolyte to the electrodes 12, 14. The frame structure 20 may form an inlet manifold 112 and an outlet manifold 114. For example, the inlet manifold 112 may include a stack inlet conduit 22 (i.e., riser) and cell inlet manifolds 26 fluidly connected thereto. The outlet manifold 114 may include a stack outlet conduit 24 (i.e., riser) and cell outlet manifolds 28 fluidly connected thereto. According to some embodiments, the inlet manifold 112 may include only one inlet manifold, or it may include first and second inlet manifolds, and the outlet manifold 114 may include only one outlet manifold, or it may include first and second outlet manifolds, as described in detail below.

The stack inlet and outlet conduits 22, 24 may be formed by aligning openings formed in the first and second frames 20A, 20B. The cell inlet and outlet manifolds 26, 28 may be disposed between the first and second frames 20A, 20B of each flow battery cell 10. For example, the cell inlet and outlet manifolds 26, 28 may be channels or grooves formed in upper and/or lower surfaces of one or more of the first and second frames 20A, 20B. For example, the cell inlet and outlet manifolds 26, 28 may be formed in upper surfaces of the first and second frames 20A 20B. However, according to some embodiments, the cell inlet and outlet manifolds 26, 28 may be formed in lower surfaces of the first and second frames 20A, 20B, or on opposing upper and lower surfaces of the first and second frames 20A, 20B.

In some embodiments, the cell inlet and outlet manifolds 26, 28 may extend between the first and second frames 20A, 20B, such that the electrolyte may flow through the reaction zones 18.

Accordingly, electrolyte may flow in the direction of the arrows of FIG. 2A. In particular, the electrolyte may flow through the stack inlet conduit 22, the cell inlet manifolds 26 and into the reaction zones 18. The electrolyte then flows across the electrodes 12, 14, is collected by the cell outlet manifolds 28, and then passes through the stack outlet conduit 24.

During a charge mode, the electrolyte provides zinc and bromine ions to the electrodes 12, 14. For example, a voltage may be applied to the first electrode 12, which results in the plating of a metallic layer 30 on lower surfaces of the first electrodes 12. The metallic layer 30 may be formed from zinc disposed in the electrolyte as zinc bromide. For example, in a zinc-bromide flow battery, during charge mode, zinc of the zinc bromide undergoes a reduction process (e.g., Zn²⁺+2e⁻→Zn) at the first electrode 12, while the bromine undergoes an oxidation process (e.g., Br⁻→Br₂+2e⁻) at the second electrode 14. The process is reversed during a discharge mode, thereby deplating the metal layer 30, while using the same electrolyte flow path configuration. As such, the electrolyte is provided in a “flow-by” flow path configuration, during both the charge and discharge modes. The electrolyte may provide bromine during the discharge mode.

Referring to FIG. 2B, the stack 101 includes multiple flow battery cells 10A. The stack 101 is similar to the stack 100, so only the differences therebetween will be describe in detail. The stack 101 includes a frame structure 20 configured to support the first and second electrodes 12, 14, such that reaction zones 18 and separation zones 19 are formed therebetween. In particular, the frame structure 20 includes first frames 20C configured to support the first electrodes 12, and second frames 20D configured to support the second electrodes.

The frame structure 20 includes inlet and outlet manifolds 113 and 115 fluidly connected to the reaction zones 18, and may be configured to provide the electrolyte thereto. The inlet manifold 113 may include a stack inlet conduit 22 and cell inlet manifolds 26 fluidly connected thereto. The outlet manifold 115 may include a stack outlet conduit 24 and cell outlet manifolds 28 fluidly connected thereto.

The cell inlet manifolds 26 are not disposed between the frames 20C, 20D of adjacent battery cells 10A. In other words, the inlet manifolds 113 are not fluidly connected to the separation zones 19, such that no electrolyte is provided thereto. At least some electrolyte flows through the second electrodes 14 and between conductive elements 13, and then out through the cell outlet manifolds 28 and the stack outlet conduit 24, as discussed below with reference to FIG. 2C. Accordingly, the stack 101 may include the conductive elements 13 which may be configured to electrically connect electrodes 12, 14 of adjacent flow battery cells 10A. The conductive elements 13 may operate as spacers and may be in the form of ribs, bars, or similar electrically connective structures.

Referring to FIG. 2C, the stack 102 includes multiple flow battery cells 11, as shown in FIG. 1C. While two flow battery cells 11 are shown, the stack 102 may include any suitable number of flow battery cells 11. The stack 102 is similar to the stacks 100, 101, so only differences therebetween will be discussed in detail.

The stack 102 includes a frame structure 20 including first frames 21A and second frames 21B. The electrolyte may flow into the reaction zones 18 through an inlet manifold 112 including a stack inlet conduit 22 and cell inlet manifolds 26, as described with regard to the stack 100. However, the second phase of the electrolyte may flow through the through holes 15 of the second electrodes 14A and into separation zones 19 formed between the flow battery cells 11. As such, the stack 102 includes an outlet manifold 114 configured to receive electrolyte from the reactions zones 18 and the separation zones 19. In particular, cell outlet manifolds 28 that are connected to the separation zones 19 are configured to transport the second phase to the to the stack outlet conduit 24. Accordingly, the stack 102 may be referred to as having a “flow-through” flow path configuration.

The electrolyte may flow along the flow-through flow path configuration during a charge mode and a discharge mode. During charge mode, the electrolyte flow through the second electrodes 14A may allow for additional reactants to flow through the stack 102. During discharge mode, electrolyte flow through the second electrodes 14A provides for greater reaction surface area. However, according to some embodiments, the electrolyte may flow primarily through the reaction zones 18 (flow-by flow path configuration) during a charge mode, and may flow in the flow-through configuration during the discharge mode.

FIG. 2D is a schematic view of a flow battery system 150, according to various embodiments of the present disclosure. Referring to FIG. 2D, the system 150 includes two stacks 200, a pump 138, and an electrolyte reservoir 120. However, the present disclosure is not limited to any particular number of stacks 200. For example, the system 150 may include one stack 200, or three or more stacks 200. Each stack 200 may comprise the stack 100, 101 and/or 102 described above or any other suitable stack.

The reservoir 120 may made of an insulating material, such as a polymer or glass material and can assume the shape of a polyhedron, cylinder, or sphere. For example, the reservoir may be made of HDPE, polypropylene, PVDF, Teflon, borosilicate glass, and/or aluminosilicate glass.

The system 150 may include an electrolyte 122 disposed in the reservoir 120. The electrolyte 122 may form a first phase 122A and a second phase 122B. The first phase 122A may include a lighter metal-halide electrolyte (e.g., aqueous zinc bromide). The second phase 122B may include a concentrated halogen reactant (e.g., non-aqueous sequestered bromine, i.e., organic bromine complex). The first phase 122A may provide a reaction material during a charge mode of the system 150. The non-aqueous second phase 122B may act as a sequestering agent for the chemical reactions during the charge mode and may provide a reaction material source during the discharge mode.

The system 150 may include first, second, and third inlet conduits 130, 132, 134, which may be collectively referred to as a “system inlet conduit”. Herein, a “conduit” may refer to a pipe, manifold, or the like. The first inlet conduit 130 is configured to supply the first phase 122A to a valve 136 or directly to the pump 138. For example, an inlet end of the first inlet conduit 130 may be disposed in the first phase 122A in a middle or top portion of the reservoir 120. The second inlet conduit 132 is configured to supply the second phase 122B to the valve 136. For example, an inlet end of the second inlet conduit 132 may be disposed in the second phase 122B in a bottom portion the reservoir 120. The valve 136 is connected to the pump 138 and may be configured to selectively control the flow of the first and/or second phases 122A, 122B through the first and second inlet conduits 130, 132. In other words, the valve 136 may operate to control the relative amounts of the first and second phases 122A, 122B that are supplied to the stack 200. Herein, the first, second, and third inlet conduits 130, 132, 134, the valve 136, and the pump 138 may be collectively referred to as an “inlet conduit system”.

For example, in the charge mode, the valve 136 may close the second inlet conduit 132 and open the first inlet conduit 130, such that only the first phase 122A is supplied to the pump 138. In the discharge mode, the valve 136 may open the second inlet conduit 132 and the first inlet conduit 130, such that both phases 122A, 122B may be provided to the stack 200. According to some embodiments, the both phases 122A, 122B may be supplied to stack 200 during the discharge mode and the charge mode. In other embodiments, relative amounts of the first and second phases 122A, 122B may be controlled during charge and discharge modes. For example, relatively more of the first phase 122A and relatively less of the second phase 122B may be provided to the stack 200 during the charge mode, and relatively less of second phase 122B and relatively more of the first phase 122A may be provided to the stack 200 during the discharge mode.

In the alternative, the valve 136 may be disposed on only the second inlet conduit 132, such that the first inlet conduit 130 may be unvalved. Therefore, when the pump 138 operates, the first phase 122A continuously flows through the first inlet conduit 130, while flow of the second phase 122B through the second inlet conduit 132 is controlled (e.g., permitted or prevented) by the valve 136.

The pump 138 is connected to the stacks 200 by the third inlet conduit 134. The pump 138 may any type of pump suitable for pumping the electrolyte 122 to the stacks 200 through the third inlet conduit 134. For example, the pump 138 may be a centrifugal pump according to some embodiments.

The stacks 200 may each include an inlet manifold 112 (or 113 as described above), an outlet manifold 114 (or 115 as described above), and flow battery cells 10 (or 10A or 11 as described above). The flow battery cells may be horizontally positioned, and may be stacked vertically and connected in series. The flow battery cells include first electrodes 12 and second electrodes 14, which are separated by reaction zones 18 and separation zones 19 described above.

The inlet manifolds 112 may be configured to receive the electrolyte 122 from the third inlet conduit 134 and supply the electrolyte 122 to the reaction zones 18. The outlet manifold 114 may be configured to receive the electrolyte 122 from the reaction zones 18 and the separation zones 19, and supply the electrolyte to a return conduit 140.

The return conduit 140 may be configured to transport the electrolyte 122 from the stacks 200 to the reservoir 120. In particular, an outlet end of the return conduit 140 may be disposed in the first phase 122A.

The flow battery system 150 may include one or more controllers 402, which may be used, for example, for controlling a rate of the pump 138. The controller 402 may be a digital or analog circuit, or may be a computer. According to alternative embodiments, substantially equal amounts of the first and second phases 122A and 122B may be supplied during both charge and discharge modes. In this case, the valve 136 may be omitted.

According to other embodiments, during the charge mode, the valve 136 may be adjusted (e.g., closed) such that more of the first phase 122A is supplied to the stack 200 than the second phase 122B. In some embodiments, substantially all of the electrolyte 122 supplied during the charge mode may be the first phase 122A. During the discharge mode, the valve 136 may be adjusted (e.g., opened) such the first and second phases 122A, 122B are both supplied to the stack 200. However, according to some embodiments, more of the second phase 122B is supplied to the stack 200 than the first phase 122A, during the discharge mode. Accordingly, the system 150 may be operated by flowing the electrolyte 122 along the flow path described above, e.g., the same flow path, during both the charge mode and discharge mode.

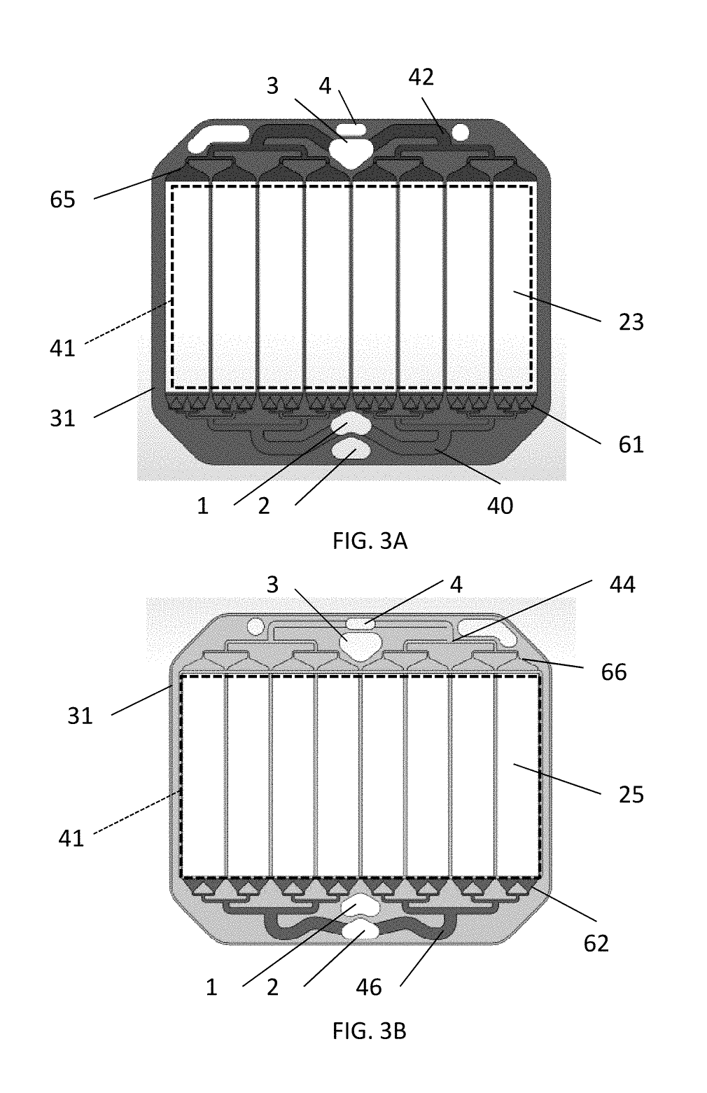

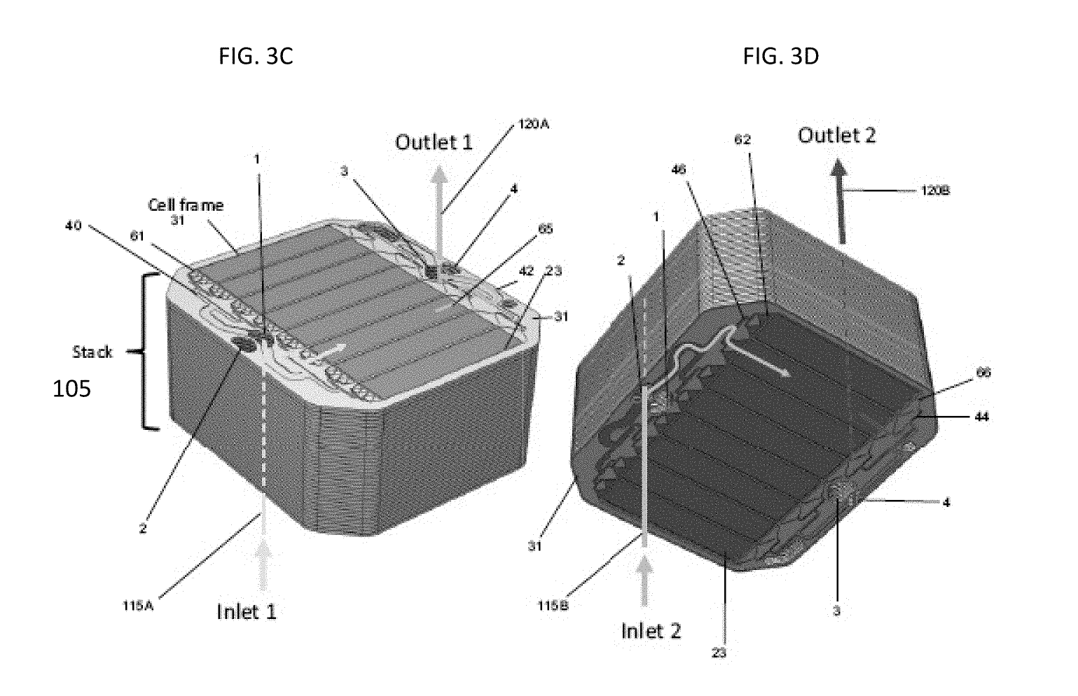

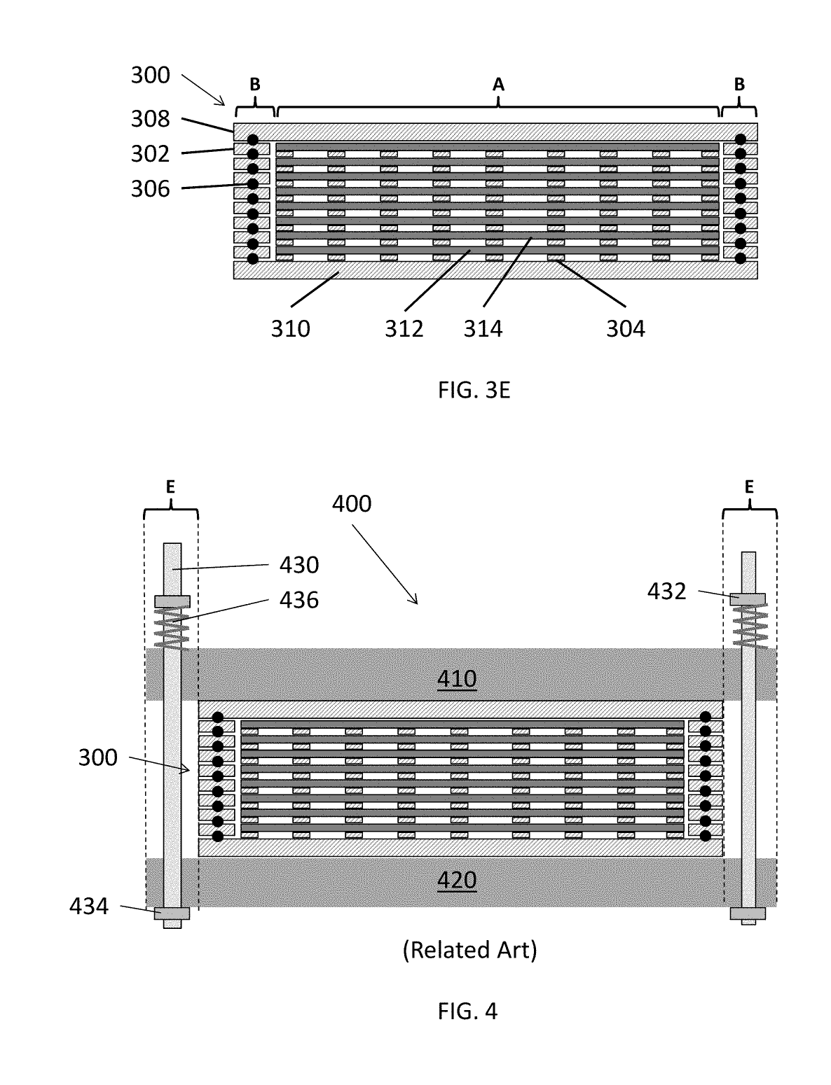

FIGS. 3A and 3B illustrate the features of the top and bottom surfaces, respectively, of a cell frame 31, according to various embodiments of the present disclosure. The frame 31 includes a main inlet manifold 1, the secondary inlet manifold 2 and the outlet manifolds 3, 4. The manifolds 1-4 are respective openings through the frame 31 which align with similar openings in other stacked frames 31 to form the manifolds. Thus, the inlet manifolds 1, 2 are formed by aligned inlet manifold openings in the stack of cell frames while the outlet manifolds are formed by aligned outlet manifold openings in the stack of cell frames. The frames also include at least one inlet distribution (e.g., flow) channel and at least one outlet distribution channel.

For example, as shown in FIGS. 3A and 3B, the upper and lower surfaces of the frame 31 each contain one inlet distribution channel (e.g., 40 on the upper side and 46 on the lower side) and one outlet distribution channel (e.g., 42 on the upper side and 44 on the lower side). These channels 40-46 comprise grooves in the respective surface of the frame 31. The distribution (e.g., flow) channels 40, 42, 44, 46 are connected to the active area 41 (e.g., opening in middle of frame 31 containing the electrodes 23, 25) and to a respective stack inlet or outlet manifold 1, 3, 4 and 2. The inlet distribution channels 40, 46 are configured to introduce the electrolyte from the respective stack inlet manifold 1, 2 to the reaction zone 18 or the flow channel(s) (i.e., separation zones) 19, and the outlet distribution channels 42, 44 are configured to introduce the electrolyte from the reaction zone 18 or the flow channel(s) to the respective outlet manifold 3, 4. Since the distribution/flow channels 40-46 deliver the electrolyte to and from each cell, they may also be referred to as the cell manifolds.

The electrolyte flows from the main inlet manifold 1 through inlet flow channels 40 and inlet 61 in the frame 31 to the active area 41. As illustrated in FIG. 3A, only the main inlet manifold 1 is fluidly connected to the inlet channels 40 on the top of the frame 31. In the embodiment illustrated in FIG. 3A, the charge mode inlet manifold 1 connects to two flow channels 40 which successively divide into sub-channels (i.e., flow splitting nodes where each channel is split into two sub-channels two or more times) to provide a more even and laminar electrolyte flow to the electrodes 23, 25. After passing across the electrodes 23, 25, the electrolyte exits the cells from outlet 65 into exit flow channels 42 on an opposite end or side of the frame 31 from the main inlet manifold 1. The electrolyte empties from the exit (i.e., outlet) flow channels 42 to a first stack outlet manifold 3. Exit channels 42 may also comprise flow splitting nodes/sub-channels as shown in FIG. 3A.

As illustrated in FIG. 3B, on the bottom side of the cell frame 31, the second inlet manifold 2 is connected to bottom purge inlet channels 46 while the main manifold 1 is fluidly isolated from the purge inlet channels 46. While the secondary inlet manifold 2 is shown as being located closer to the edge of the frame 31 than the main manifold 1 in FIGS. 3A and 3B, the positions of the manifolds 1 and 2 may be reversed. Thus, manifold 1 may be located closer to the frame 31 edge than manifold 2, as shown in FIG. 2A or the manifolds 1, 2 may be located side by side. The second stack outlet manifold 4 is connected to the electrochemical cells via outlet 66 and bottom exit channels 44 on the bottom surface of the frame 31.

FIGS. 3C and 3D illustrate the flows through the manifolds in a stack 105 of cell frames 31. The stack 105 of cell frames 31 supports flow cells as described above. The stack of cell frames 31 is preferably a vertical stack in which adjacent cell frames 31 are separated in the vertical direction.

As shown in FIG. 3C, the majority of the liquid flow in the charge and discharge mode flows upward through the main inlet manifold 1 in the frames 31. The flow exits the manifold 1 in each frame to two flow channels 40 which successively divide into sub-channels (i.e., flow splitting nodes where each channel is split into two sub-channels two or more times). The flow then flows from sub-channels 40 through inlet 61 into the reaction zone 18 of each cell. After passing through the reaction zone between the electrodes 23, 25 of each cell, the flow exits the cells from outlet 65 into exit flow channels 42 on an opposite end or side of the frame 31 from the main inlet manifold 1. The flow empties from the exit flow channels 42 to the first stack outlet manifold 3. As described above, in discharge mode, a portion of the flow passes through the electrode 23 into the flow channel(s) 19. After passing through the flow channel(s) 19, the flow is provided through outlet 66 into exit flow channels 44. The flow empties from the exit flow channels 44 to the second stack outlet manifold 4.

As shown in FIG. 3D, the minority of the liquid flow (e.g., the purge flow) flows in the charge and discharge mode flows upward through the secondary inlet manifold 2 in the frames 31. The flow exits the manifold 2 in each frame to two flow channels 46 which successively divide into sub-channels (i.e., flow splitting nodes where each channel is split into two sub-channels two or more times). The flow then flows from sub-channels 46 through outlet 62 into the flow channel(s) 19 between each cell. After passing through the flow channel(s) 19, the flow is provided through outlet 66 into exit flow channels 44. The flow empties from the exit flow channels 44 to the second stack outlet manifold 4.

FIG. 3E is a sectional view of a flow battery stack 300, according to various embodiments of the present disclosure. Referring to FIG. 3E, the stack 300 may include cell frames 302, compression rings 306 disposed between the cell frames 302, and positive and negative electrodes 312, 314 disposed on the cell frames 302. The stack 300 may include ribs or other spacers 304 configured to support and/or separate the electrodes 312, 314. The stack 300 may also include stack end plates 308, 310 disposed on upper and lower ends of the stack 300.

The stack 300 may include a central portion A and an edge portion B that at least partially surrounds the central portion A. The central portion A of the stack 300 may be relatively rigid, due at least in part to the ribs 304 and the electrodes 312, 314. The edge portion B of the stack 300 may be relatively compliant (i.e., less rigid and more compliant than the central portion A), due at least in part to the presence of the compression rings 306 and the flexibility of the cell frames 302, which may be made of a relatively compliant polymer material. When in operation, the stack 300 may be disposed in a compression assembly, in order to insure proper electrical and/or fluid connections within the stack 300. In particular, if the stack is not properly compressed, zinc plating quality and/or stack performance may be reduced.

FIG. 4 is a side cross-sectional view of a conventional compression assembly 400 used to compress a flow battery stack, such as the stack 300 of FIG. 3E. Referring to FIG. 4, the compression assembly 400 includes a first end plate 410, a second end plate 420, tie rods 430, upper and lower fasteners 432, 434 (e.g., clamps) and biasing devices 436. The tie rods 430 extend through the first and second end plates 410, 420, such that the first and second end plates 410, 420 are aligned with one another. The stack 300 may be disposed between the first and second end plates 410, 420.

The upper and lower fasteners 432, 434 are disposed on (e.g. fixed to) the tie rods 430, such that the first and second end plates 410, 420 are held in position with respect to the tie rods 430 and/or stack 300. The biasing devices 436 may be disposed on the tie rods 430, between the upper fasteners 432 and the first end plate 410. The biasing devices 436 bias the first end plate 410 toward the second end plate 420, such that the stack 300 is compressed. The first and second end plates 410, 420 include cantilevered edge portions E upon which the biasing force from the biasing devices 436 is applied.

Since the biasing devices 436 are disposed around the tie rods 430, the total amount of biasing force may be constrained by the number and size of the tie rods 430. In other words, achieving the appropriate total compression rate may require the use of more tie rods or larger tie rods that actually necessary to apply the desired compression load. In addition, the biasing devices 436 add to the overall height of the compression assembly 400.

Further, the biasing force may deform (e.g., bend) the first and second end plates 410, 420. This results in more force being applied to the edge portion B of the stack 300, which deforms the stack 300 (e.g., bends the edge portion B). This deformation may be mitigated by increasing the stiffness of one or both of the end plates 410, 420. However, this undesirably increases the cost and/or weight of a compression assembly.

In view of the above and/or other problems, the present disclosure provides compression assemblies configured to apply a biasing force to a flow battery stack such that more of the biasing force (i.e., higher pressure) is applied to the central portion A of the stack 300 containing the electrodes than the edge portion B of the stack containing the cell frames 302. For example, at least 75% of the biasing force is applied to electrodes of the stack (i.e., to the central portion A of the stack) and 25% or less of the biasing force is applied to the cell frames (i.e., to the edge portion B of the stack). For example, at least 80%, 85%, 90%, or 95%, of the biasing force may be borne by the electrodes, such that cell frames surrounding the electrodes receive less than 20% (e.g., 0 to 15% of the biasing force or pressure). In this configuration, the cell frames and the end plates are not bent or are bent less by the biasing force of the compressing assembly and its biasing elements.

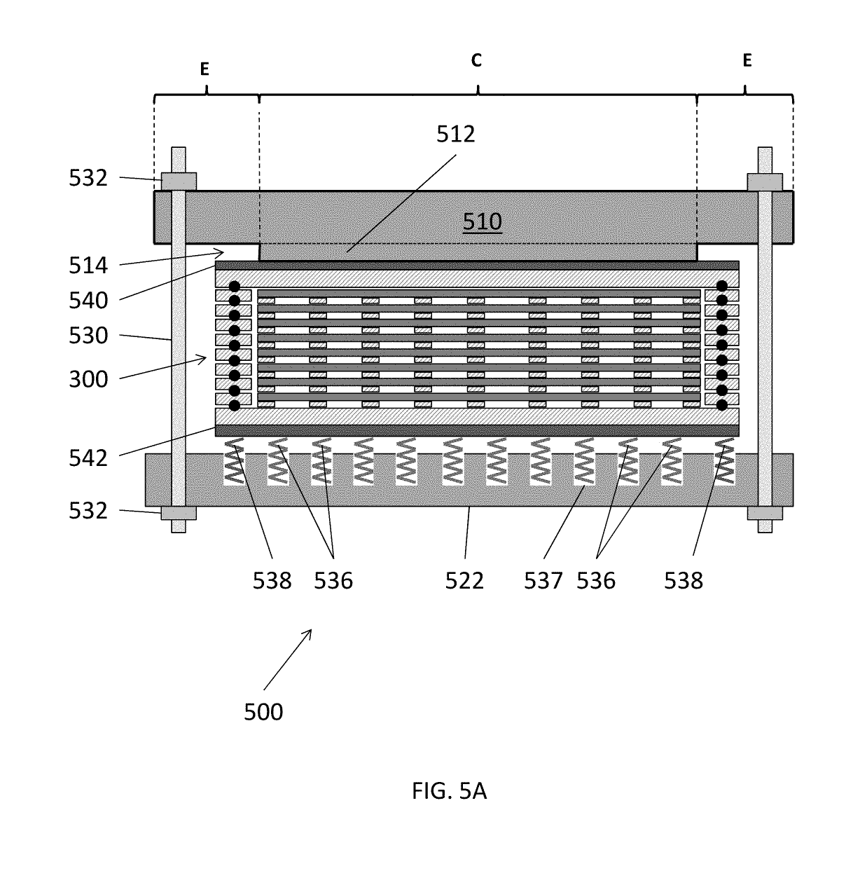

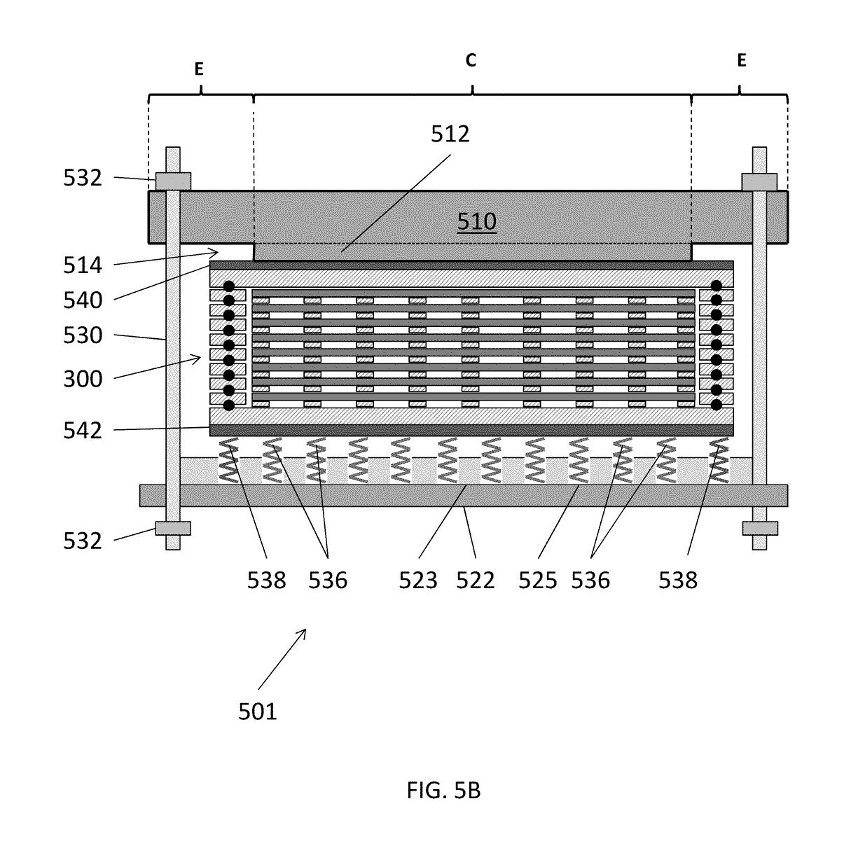

FIG. 5A is a side cross-sectional view of a compression assembly 500, according to various embodiments of the present disclosure. The compression assembly 500 is configured compress a flow battery stack 300, while reducing or preventing deformation of the stack 300. While the stack 300 is shown, the present disclosure is not limited to any particular type of flow battery stack. For example, any of the flow battery stacks described above may be disposed in the compression assembly 500.

Referring to FIGS. 3E and 5A, the compression assembly 500 includes first and second end plates 510, 522, a connecting element to connect the end plates 510, 522, such as tie rods 530 and fasteners 532 (e.g., clamps or bolts), and first and second support plates 540, 542. The tie rods 530 are configured to connect the end plates 510, 522. The stack 300 may be disposed between the first and second support plates 540, 542, which may be disposed between the end plates 510, 522. The fasteners 532 are disposed on (e.g., clamped or fastened to) the tie rods 530 and are configured to hold the end plates 510, 522 in position with respect to the rods 530 and/or stack 300.

The first end plate 510 includes a central portion C, a cantilevered edge potion E that at least partially surrounds the central portion C, and central boss 512 that extends from the central portion C and vertically overlaps with the stack 300. As compared to the conventional compression assembly 400, the first end plate 510 includes a larger edge portion E, due at least in part to the presence of the boss 512. The boss 512 may be configured to vertically overlap with the more rigid central portion A of the stack 300, without vertically overlapping with the less rigid edge portion B of the stack 300.

In particular, the boss 512 forms a relief space(s) 514 between the edge portion B of the stack 300 and the edge portion E of the first end plate 510. The relief space 514 allows the first end plate 510 to bend without contacting the stack 300. Therefore, even if the first end plate 510 is deformed by a biasing force (e.g., clamping pressure), excessive pressure will not be applied to the edge portion B of the stack 300.

The second end plate 522 may include first biasing devices 536 and second biasing devices 538. The biasing devices 536, 538 may be nested in holes (e.g., recesses) 537 formed in the second end plate 522, as shown in FIG. 5A. In the alternative, the biasing devices 536, 538 may be attached to an upper surface of the second end plate 522. The biasing devices 536, 538 may be compression springs or the like. The biasing devices 536, 538 may be configured to bias the stack 300 against the first end plate 510, such that the stack 300 is compressed. In particular, the biasing devices 536, 538 may be configured to maintain a clamping/biasing pressure on the stack 300 as compressed components undergo dimensional changes, due to, for example, component creeping, thermal contraction/expansion, or the like.

The first biasing devices 536 may vertically overlap with the boss 512 and the central portion A of the stack 300. The second biasing devices 538 may vertically overlap with the edge portion E of the first end plate 510 and edge portion B of the stack 300. In other words, the second biasing devices 538 may surround the first biasing devices 536. The first biasing devices 536 may have a higher stiffness than the second biasing devices 538. Accordingly, a higher pressure may be applied to the rigid central portion A of the stack 300 than to the more compliant edge portion B of the stack 300. In the alternative, the biasing devices 536, 538 may be the same as each other.

The first support plate 540 may be disposed between the boss 512 and the stack 300, and the second support plate 542 may be disposed between the biasing devices 536, 538 and the stack 300. The first and second support plates 540, 542 may respectively cover substantially all of opposing first and second surfaces of the flow battery stack 300. The support plates 540, 542 may be more rigid than at least a portion of the stack 300, such as the edge portion B. The support plates 540, 542 may support the stack 300 and distribute the biasing forces more evenly across the stack 300. As such, the support plates 540, 542 may further reduce stack bending. However, in some embodiments, the support plates 540, 542 may be omitted.

The tie rods 530 may extend through the edge portion E of the first end plate 510 and an end region of the second end plate 522. Any suitable number of tie rods 530 may be included. For example, if rectangular end plates and four tie rods 530 are included, the tie rods 530 may be disposed adjacent to the corners of the end plates 510, 522. However, the present disclosure is not limited to any particular number or configuration of tie rods. Further, in some embodiments, the tie rods 530 may be replaced with any suitable connecting element, such as clamps, brackets, or the like.

FIG. 5B is a side cross-sectional view of a modified the flow battery compression assembly 501 similar to the flow battery compression assembly 500 of FIG. 5A. Accordingly, only the differences therebetween will be discussed in detail.

Referring to FIG. 5B, instead of the biasing devices 536, 538 being disposed in recesses formed in the second end plate 522, the compression assembly 501 includes a separate alignment housing 523 including through holes 525 in which the biasing devices 536, 538 are disposed. The alignment housing 523 may be a plate supported by the second end plate 522.

The alignment housing 523 may be formed of a plastic or foam material. In particular, because the alignment housing 523 is supported by the second end plate 522, the alignment housing 523 may be formed of a less rigid material than the second end plate 522. Further, the alignment housing is not subjected to compressive forces generated by other elements of the compression assembly 501.

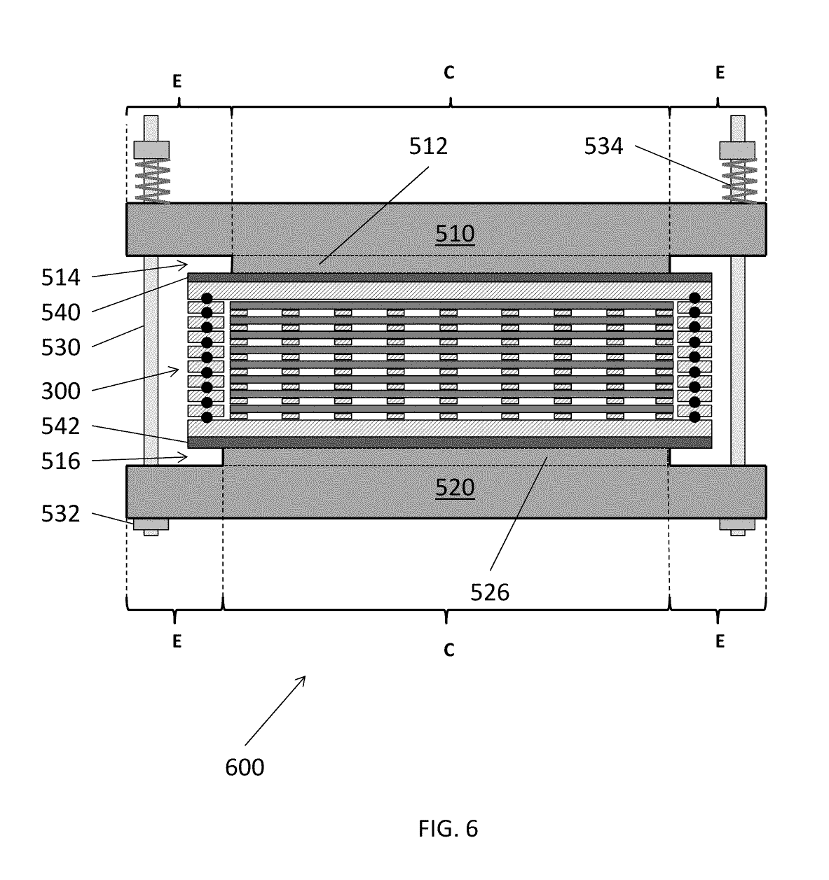

FIG. 6 is a side cross-sectional view of a compression assembly 600, according to various embodiments of the present disclosure. The compression assembly 600 is similar to the compression assembly 500, so only the differences therebetween will be discussed in detail.

Referring to FIGS. 3E and 6, the compression assembly 600 includes a second end plate 520 that includes a cantilevered edge portion E, a central portion C, and a central boss 526, similar to the central boss 512 of the first end plate 510. In addition, the compression assembly 600 includes biasing devices 534 configured to bias the first end plate 510 toward the stack 300. The biasing devices 534 may be, for example, compression springs, Belleville washers, or the like. While the biasing devices 534 are shown to be disposed between the fasteners 532 and the first end plate 510, the biasing devices 534 may alternatively or additionally be disposed between the fasteners 532 and the second end plate 520.

The bosses 512, 526 vertically overlap with the central portion A of the stack 300 and with each other, but preferably do not overlap with edge portions B of the stack 300. As such, first relief spaces 514 are formed between the cantilevered edge portion E of first end plate 510 and the first support plate 540, and second relief spaces 516 are formed between a cantilevered edge portion E of the second end plate 520 and the second support plate 542. The first and second relief spaces 514, 516 allow the end plates 510, 520 to bend without contacting the stack 300. Accordingly, if the first and/or second end plates 510, 520 become deformed, excessive force is not applied to the edge portion B of the stack 300. Therefore, excessive force is not applied to the relatively compliant edge portion B of the stack 300.

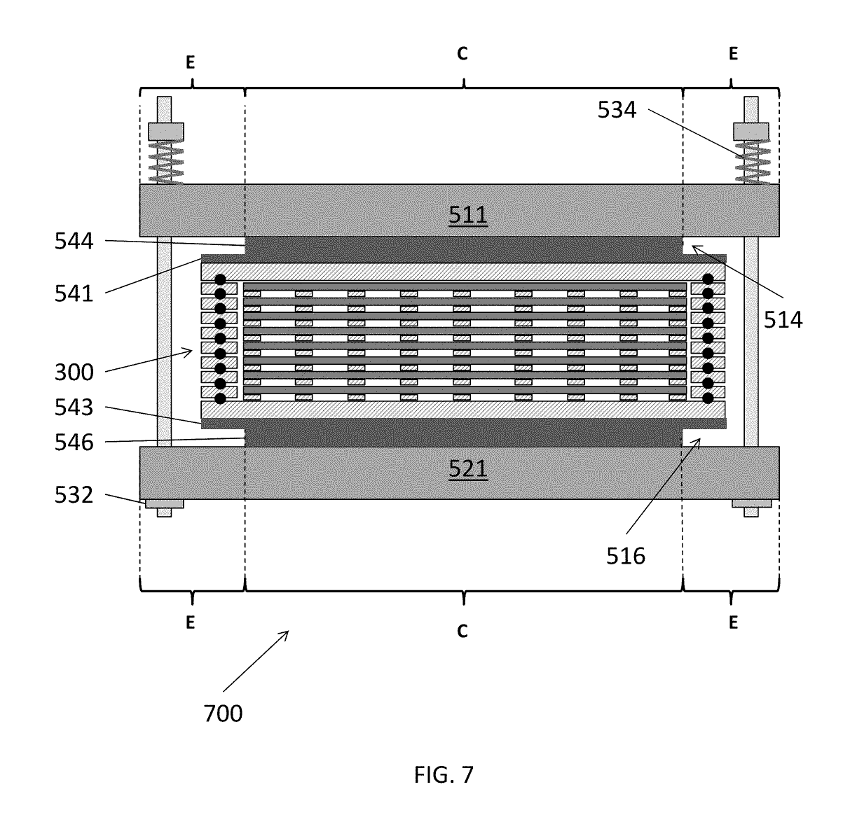

FIG. 7 is a side cross-sectional view of a compression assembly 700, according to various embodiments of the present disclosure. The compression assembly 700 is similar to the compression assembly 600, so only the differences therebetween will be discussed in detail.

Referring to FIGS. 3E and 7, the compression assembly 700 includes first and second end plates 511, 521, a first support plate 541 including a first boss 544, and a second support plate 543 including a second boss 546. The first boss 544 extends from the first support plate 541 toward the first end plate 511. The second boss 546 extends from the second support plate 543 toward the second end plate 521. The first and second bosses 544, 546 may be respectively integrated with the first and second support plates 541, 543. In other words, the first support plate 541 and first boss 544 may be permanently bonded to one another or formed from a single piece of material, and the second support plate 543 and the second boss 546 may be permanently bonded to one another or formed from a single piece of material.

The bosses 544, 546 vertically overlap with the central portion A of the stack 300 and with each other, but preferably do not overlap with edge portions B of the stack 300. As such, first and second relief spaces 514, 516 are formed between edge portions of the support plates 541, 543 and edge portions E of the end plates 511, 521. Accordingly, if the first and/or second end plates 511, 521 become deformed, excessive force is not applied to the edge portion B of the stack 300. Therefore, the relatively compliant edge portion B of the stack 300 is protected from bending.

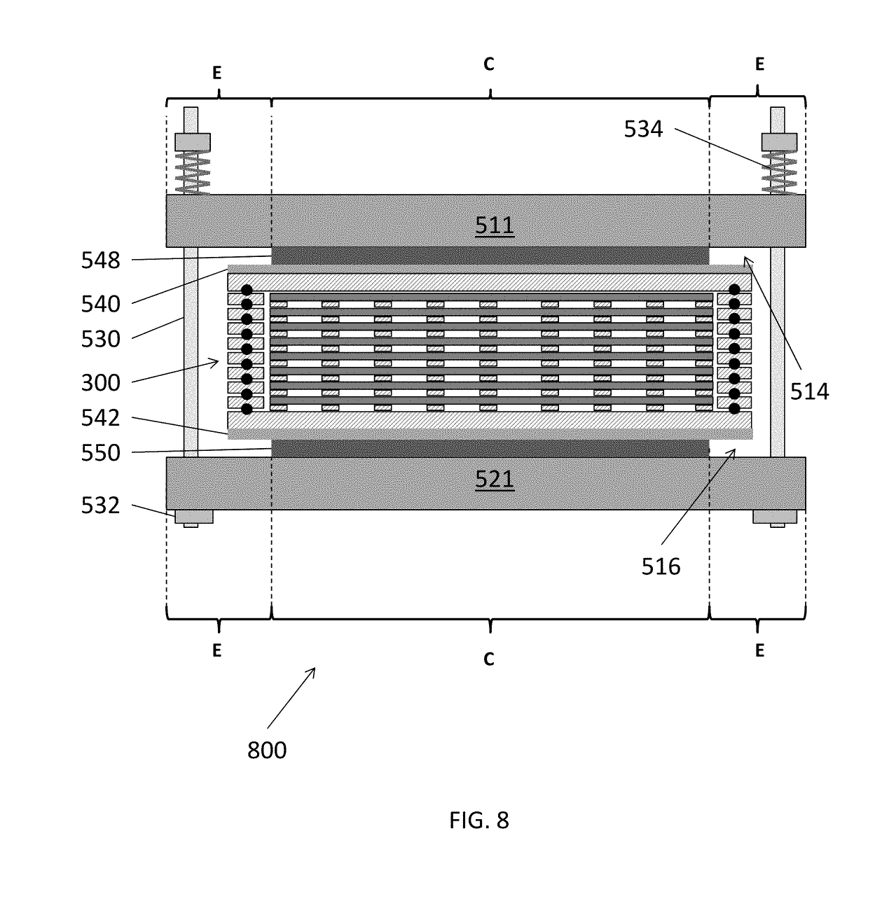

FIG. 8 is a side cross-sectional view of a compression assembly 800, according to various embodiments of the present disclosure. The compression assembly 800 is similar to the compression assembly 700, so only the differences therebetween will be discussed in detail.

Referring to FIGS. 3E and 8, the compression assembly 800 includes a first boss 548 disposed between the first support plate 540 and the first end plate 511, and a second boss 550 disposed between the second support plate 542 and the second end plate 521. The first and second bosses 548, 550 may be in the form of plates that are not bonded or permanently attached to the respective first and second support plates 542. For example, the first and second bosses 548, 550 may be formed of a different material and/or may have a different rigidity than the first and second support plates 542.

The bosses 548 and 550 vertically overlap the central portion A of the stack 300 and with each other, but preferably do not overlap with edge portions B of the stack 300. As such, the first and second relief spaces 514 and 516 may be formed. Accordingly, if the first and/or second end plates 511, 521 become deformed, excessive force is not applied to the edge portion B of the stack 300. Therefore, the relatively compliant edge portion B of the stack 300 is protected from bending.

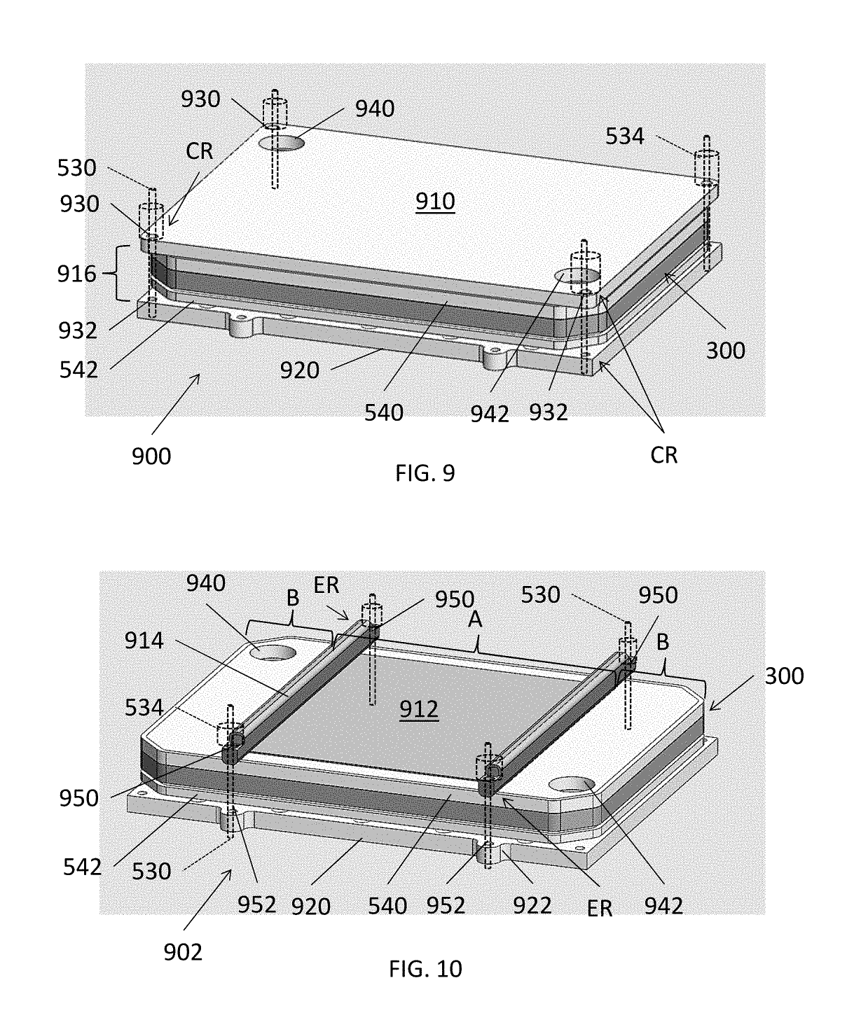

FIG. 9 is a side perspective view of a compression assembly 900, according to various embodiments of the present disclosure. The compression assembly 900 is similar to the compression assembly 700, so only the differences therebetween will be discussed in detail.

Referring to FIGS. 3E and 9, the compression assembly 900 may include a first end plate 910 and a second end plate 920. The flow battery stack 300, the first support plate 540, and the second support plate 542, may be stacked between the end plates 910, 920. Corners of the stack 300 and the support plates 540, 542 may be beveled, such that corner regions CR of the end plates 910, 920 are cantilevered outside the perimeter of the stack 300 (e.g., extend past edges of the support plates 540, 542). Accordingly, relief spaces 916 are at least partially defined by the beveled corners of the stack 300 and support plates 540, 542, and opposing corner regions CR of the end plates 910, 920.

The tie rods 530 extend through the openings 930, 932 in the corner regions CR of the end plates 910, 920 and the relief spaces 916, to connect the end plates 910, 920. The biasing devices 534 may be disposed on the tie rods 530, in order to bias the end plates 910, 920 toward one another. Although not shown, the compression assembly 900 may include fasteners to secure the tie rods 530. However, in some embodiments, one or more of the end plates 910, 920 may be threaded. For example, the tie rods 530 may be threaded into openings 930, 932 formed in the second end plate 930, and corresponding fasteners may be omitted.

Because the corner regions CR are cantilevered, if the first and/or second end plates 910, 920 become deformed during biasing, excessive force is not applied to the edge portion B of the stack 300. Therefore, the relatively compliant edge portion B of the stack 300 is protected from bending. Fluid (i.e., electrolyte) inlet 940 and outlet 942 openings (i.e., manifolds) may be formed in the end plates 910, 920.

FIG. 10 is a side perspective view of a compression assembly 902, according to various embodiments of the present disclosure. The compression assembly 902 is similar to the compression assembly 900, so only the differences therebetween will be discussed in detail.

Referring to FIGS. 3E and 10, the compression assembly 902 may include a first end plate 912, a second end plate 920, and pressure bars 914 disposed on opposing sides of the first end plate 912. The flow battery stack 300, the first support plate 540, and the second support plate 542, may be stacked between the end plates 912, 920. The tie rods 530 may be configured to connect the pressure bars 914 to the second end plate 920, and the biasing devices 534 may be configured to bias the pressure bars 914 and the second end plate 920 toward one another.

In some embodiments, the pressure bars 914 may be attached to the first end plate 912 via fasteners or by welding, for example. The first end plate 912 may face the rigid central portion A of the stack 300 (e.g., may not directly overlap with the edge portions B of the stack) and may be disposed between the pressure bars 914 and the stack 300. In other words, the pressure bars 914 may overlap the central portion A of the stack 300 and may not overlap or be disposed on the end portions B of the stack 300. Accordingly, the first end plate 912 may be configured to transfer the biasing force from the pressure bars 914 to the central portion A of the stack 300.

End regions ER of the pressure bars 914 may be cantilevered outside of the perimeter of the stack 300 (e.g., extend outwardly beyond corresponding edges of the support plates 540, 542, and the first end plate 912). The second end plate 920 may include protrusions 922 that are cantilevered outside of the perimeter of the stack 300. The end regions ER may face (e.g., directly overlap with) corresponding protrusions 922. The tie rods 530 may extend through respective openings 950, 952 in the end regions ER and the protrusions 922.

Although not shown, the compression assembly 902 may include fasteners to secure the tie rods 530. However, in some embodiments, one or more of the openings 950 in the pressure bars 914, the openings 952 in the protrusions 922 of the second end plate 920, and the tie rods 530 may be threaded. For example, the tie rods 530 may be threaded into openings formed in the protrusions 922 and corresponding fasteners may be omitted.

Because the end regions ER and the protrusions 922 are cantilevered from the central region A of the stack 300 and not from the end regions B, if the pressure bars 914 and/or the second end plate 922 become deformed during biasing, excessive force is not applied to the edge portion B of the stack 300. Therefore, the relatively compliant edge portion B of the stack 300 is protected from bending.

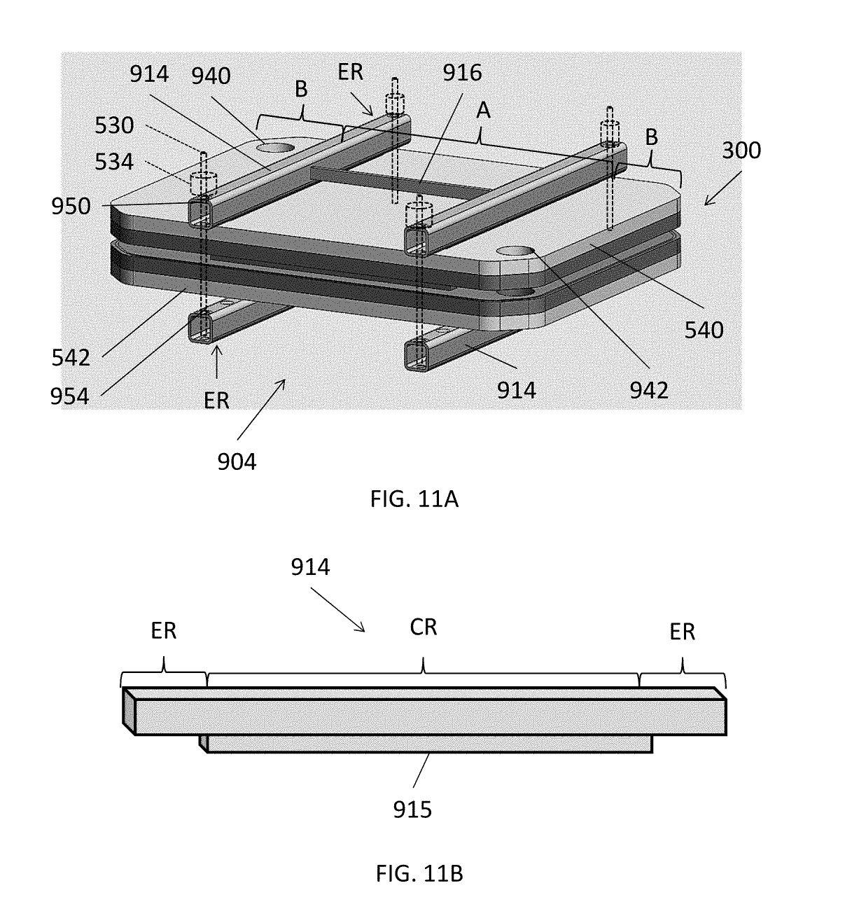

FIG. 11A is a side perspective view of a compression assembly 904, according to various embodiments of the present disclosure. FIG. 11B is a perspective view of a pressure bar 914 of FIG. 11A. The compression assembly 904 is similar to the compression assembly 902, so only the differences therebetween will be discussed in detail.

Referring to FIGS. 3E, 11A, and 11B, the compression assembly 904 may include pressure bars 914 disposed on opposing sides of the stack 300. The pressure bars 914 may be connected by stabilizing bars 916. While one stabilizing bar 916 is shown connecting two pressure bars 914, additional stabilizing bars may be included in some embodiments to connect two pressure bars. The pressure bars 914 and the stabilizing bar 916 are disposed over and under the central region A of the stack 300 and do not directly overlap the end regions B of the stack 300.

The pressure bars 914 may have a central region CR and two end regions ER disposed on opposing sides of the central region CR. The central region CR may include a boss 915. The bosses 915 may be configured to operate as contact surfaces between the pressure bars 914 and the central region A of stack 300. As such, the bosses 915 may operate to provide spacing between the end regions ER and the stack 300. In other words, the pressure bars 914 may be configured to contact only the central region A of the stack 300, via the bosses 915. Therefore, the end regions ER of the pressure bars 914 may be may be cantilevered outside of the perimeter of the stack 300 (e.g., extend past edges of the support plates 540, 542).

The tie rods 530 may extend through the end regions ER to connect the pressure bars 914, and the biasing devices 534 may be configured to bias the pressure bars 914 toward one another. The tie rods 530 extend through openings 950, 954 in the end regions ER of the pressure bars 914. Because of the spacing provided by bosses 915, if the pressure bars 914 become deformed during biasing, excessive force is not applied to the edge portion B of the stack 300. Therefore, the relatively compliant edge portion B of the stack 300 is protected from bending.

According to various embodiments, the components of the compression assemblies 500, 600, 700, 800, 900, 902, 904 may be substituted for one another. For example, a compression assembly may include a first support plate 510, the second support plate 521, and the second boss plate 550. In addition, the end plates, the pressure bars, and/or the stabilizing bars may be collectively or individually referred to as compression members. Other types of compression members which compress the stack may also be used.

As shown above, a conventional stack compression assembly may deform components of a stack, which may result in poor quality zinc plating and or reduced battery efficiency. However, the present disclosure utilizes a compression assembly to preferentially apply more pressure to a central portion of a stack containing electrodes than to edge portions of the stack containing cell frames. Thus, the embodiment compression assemblies include components that reduce and/or prevent stack deformation, without significantly increasing the cost, size, and/or weight of the compression assemblies.

Although the foregoing refers to particular preferred embodiments, it will be understood that the invention is not so limited. It will occur to those of ordinary skill in the art that various modifications may be made to the disclosed embodiments and that such modifications are intended to be within the scope of the invention. All of the publications, patent applications and patents cited herein are incorporated herein by reference in their entirety.

What is claimed is:

1. A flow battery, comprising:
a compression assembly comprising one or more biasing devices, a first compression member, and an opposing second compression member; and
a flow battery stack comprising:
stacked electrodes located in a central portion of the flow battery stack; and
cell frames located in an edge portion of the flow battery stack and that surround the electrodes,
wherein the flow battery stack is located between the first and second compression members, and
wherein the compression assembly is configured to apply a higher biasing force to the stacked electrodes located in the central portion of the flow battery stack than to the cell frames located in the edge portion of the flow battery stack.

2. The flow battery of claim 1, further comprising:
a reservoir comprising a metal halide electrolyte;
an inlet conduit fluidly connecting the reservoir to an inlet of the flow battery stack;
an outlet conduit fluidly connecting the reservoir to an outlet of the flow battery stack; and
a pump configured to pump the electrolyte through the first inlet conduit.

3. The flow battery of claim 2, wherein:
the first compression member comprises a first end plate;
the second compression member comprises a second end plate facing the first end plate; and
the flow battery further comprises tie rods connecting the first and second end plates.

4. The flow battery of claim 3, wherein:
the first end plate comprises a central portion, a cantilevered edge portion at least partially surrounding the central portion, and a central boss extending from the central portion toward the flow battery stack;
the biasing devices extend from the second end plate towards the first end plate and configured to apply a biasing force to the flow battery stack disposed between the first and second end plates; and
the central boss is vertically overlaps with a central portion of the flow battery stack and to provide pressure to the central portion of the flow battery stack, such that a relief space is disposed between the edge portion of the first end plate and the edge portion of the flow battery stack.

5. The flow battery of claim 4, wherein the biasing devices comprise:
first biasing devices having a first stiffness; and
second biasing devices having a second stiffness that is less that the first stiffness.

6. The flow battery of claim 5, wherein:
the first biasing devices vertically overlap with the central portion of the flow battery stack; and
the second biasing devices vertically overlap with the edge portion of the flow battery stack.

7. The flow battery of claim 4, further comprising:
a first support plate disposed in contact with the central boss and with the first end of the flow battery stack; and
a second support plate disposed on the biasing devices and configured to support an opposing second end of the flow battery stack.

8. The flow battery of claim 7, wherein the first and second support plates are configured to respectively cover substantially all of opposing first and second surfaces of the flow battery stack.

9. The flow battery of claim 5, wherein the biasing devices comprise compression springs disposed in recesses in the second end plate.

10. The flow battery of claim 3, wherein:
the first end plate comprises a first central portion, a cantilevered first edge portion at least partially surrounding the first central portion, and a first central boss extending from the first central portion toward the flow battery stack;
the second end plate comprises a second central portion, a cantilevered second edge portion at least partially surrounding the second central portion, and a second central boss extending from the second central portion;
the biasing devices are disposed on the tie rods and configured to bias the first end plate with respect to the second end plate; and
the first and second central bosses are configured to vertically overlap with a central portion of the flow battery stack, such that a first relief space is formed between the first edge portion and an edge portion of the flow battery stack, and a second relief space is formed between the second edge portion and the edge portion of the flow battery stack.

11. The flow battery of claim 10, wherein the biasing devices comprise compression springs or Belleview washers located on the tie rods.

12. The flow battery of claim 10, wherein the tie rods extend through the first and second edge portions.

13. The flow battery of claim 10, further comprising:
a first support plate disposed between the first boss and the flow battery stack; and
a second support plate disposed between the second boss and the flow battery stack.

14. The flow battery of claim 3, further comprising opposing first and second bosses disposed between the first and second support plates and configured to contact a central portion of a flow battery stack, such that relief spaces are respectively formed between the edge portion of the flow battery stack and edge portions of the first and second support plates.

15. The flow battery of claim 14, wherein the first and second bosses respectively comprise first and second boss plates that are not permanently attached to the respective the first and second support plates.

16. The flow battery of claim 15, wherein the first and second support plates are configured to respectively cover substantially all of opposing first and second surfaces of the flow battery stack.

17. The flow battery of claim 1, wherein the compression assembly applies at least 75% of the biasing force to the stacked electrodes located in the central portion of the flow battery stack and 25% or less of the biasing force to the cell frames located in the edge portion of the flow battery stack.

18. The flow battery of claim 17, wherein the compression assembly applies 80 to 100% of the biasing force to the stacked electrodes located in the central portion of the flow battery stack and 0 to 20% of the biasing force to the cell frames located in the edge portion of the flow battery stack.

19. The flow battery of claim 1, wherein the compression assembly applies a higher pressure to the stacked electrodes located in the central portion of the flow battery stack than to the cell frames located in the edge portion of the flow battery stack.

20. The flow battery of claim 1, wherein the stacked electrodes located in the central portion of the flow battery stack are more rigid than the cell frames located in the edge portion of the flow battery stack.

21. The flow battery of claim 3, wherein:
the first and second end plates comprise cantilevered corner regions that at least partially define relief spaces disposed outside of the flow battery stack; and
the compression assembly further comprising tie rods that extend through the relief spaces and that connect the corner regions of the first and second end plates.

22. The flow battery of claim 1, wherein:
the first compression member comprises:
a first end plate disposed on the central portion of the flow battery stack, such that the edge portion of the flow battery stack is disposed outside of the perimeter of the first end plate; and
pressure bars disposed on opposing edges of the first end plate, the pressure bars comprising cantilevered end regions that extend outside of the perimeters of the first end plate and the flow battery stack;
the second compression member comprises a second end plate that comprises protrusions that face the end regions; and
the compression assembly further comprises tie rods that connect each end region to a corresponding one of the protrusions.

23. The flow battery of claim 22, wherein the first end plate is configured to transfer the biasing force to the stacked electrodes.

24. The flow battery of claim 1, wherein:
the first compression member comprises first pressure bars disposed on opposing edges of the central portion of the flow battery stack, the first pressure bars comprising cantilevered first end regions that extend outside of the perimeter of the flow battery stack; and
the second compression member comprises second pressure bars disposed on opposing edges of the central portion of the flow battery stack, the second pressure bars comprising cantilevered second end regions that extend outside of the perimeter of the flow battery stack.

25. The flow battery of claim 24, wherein the compression assembly further comprises tie rods connecting the first end regions to the second end regions.

26. The flow batter of claim 25, wherein the compression assembly further comprises:
a first stabilizing bar connecting the first pressure bars; and
a second stabilizing bar connecting the second pressure bars.

27. The flow battery of claim 24, wherein the biasing devices are configured to bias the first and second pressure bars toward one another, such that the higher biasing force is applied to the stacked electrodes.

28. The flow battery of claim 5, further comprising an alignment housing disposed on the second end plate,
wherein the biasing devices comprise compression springs disposed in through holes formed in the alignment housing.

29. The flow battery of claim 1, wherein the first compression member comprises pressure bars disposed on the flow battery stack, each pressure bar comprising edge regions that extend outside of the perimeter of the flow battery stack, and a boss disposed between the edge regions and that contacts only the central portion of the flow battery stack, such that the edge regions do not directly contact the stack.

30. The flow battery of claim 29, wherein:
the second compression member comprises:
an end plate facing the pressure bars; and
an alignment housing disposed on the second end plate;
the biasing devices are disposed in through holes formed in the alignment housing; and
the compression assembly further comprises tie rods connecting the pressure bars and the end plate.

31. The flow battery of claim 30, wherein the alignment housing comprises a plastic or a foam material.

32. The flow battery of claim 30, wherein the biasing devices comprise:
first compression springs having a first stiffness and that vertically overlap with a central portion of the flow battery stack; and
second compression springs having a second stiffness that is less than the first stiffness, the second compression springs vertically overlapping with an edge portion of the flow battery stack.
